(19) United States
(12) Patent Application Publication
(10) Pub. No.: US 2025/0150766 A1
(43) Pub. Date: May 8, 2025

(54) METHOD FOR OPERATING A HEARING SYSTEM AND HEARING SYSTEM

(71) Applicant: Sivantos Pte. Ltd., Singapore (SG)

(72) Inventors: Thomas LOTTER, Erlangen (DE); Jordi PLANAS, Cork City (IE); Stefan SCHMITZ, Singapore (SG); Yuxuan SUN, Singapore (SG)

(21) Appl. No.: 18/935,872

(22) Filed: Nov. 4, 2024

(30) Foreign Application Priority Data
Nov. 3, 2023 (DE) 10 2023 210 926.3

(51) Int. Cl. H04R 25/00

(52) U.S. Cl. CPC H04R 25/55

(57) ABSTRACT

A method operates a hearing system and contains a hearing device, a remote interaction unit having a user interface for inputting a hearing-system-related user query, a linguistic data processing section coupled to the user interface, and a data cloud, coupled to the linguistic data processing section, and has a database that stores responses for the user query. The input of a hearing-device-related user query results in a content of the user query being analyzed by the linguistic data processing section and a query being sent to the data cloud. The data cloud takes the query as a basis for selecting a response from the database. The response is sent to the linguistic data processing section. The linguistic data processing section takes the response as a basis for generating an output and sends the output to the remote interaction unit, and the output is output by the remote interaction unit.

### CROSS-REFERENCE TO RELATED APPLICATION

This application claims the priority, under 35 U.S.C. § 119, of German Patent Application DE 10 2023 210 926.3, filed Nov. 3, 2023; the prior application is herewith incorporated by reference in its entirety.

### FIELD AND BACKGROUND OF THE INVENTION

The invention relates to a method for operating a hearing system containing a hearing device and a remote interaction unit. The invention also relates to a hearing system for carrying out the method.

The term “hearing system” or “hearing apparatus” denotes a single device or a group of devices and possibly nonphysical functional units that together, during operation, provide (hearing) functions for a person using the hearing system (who is subsequently referred to as the “(hearing system) user”). In the simplest case, the hearing system can consist of a single hearing device. Alternatively, the hearing system can comprise two interacting hearing devices for taking care of both ears of the user. In this case, the term used is “binaural hearing system” or “binaural hearing device”. Furthermore, the hearing system can comprise hearing-device-external components, for example a supplementary device such as an ear coupling, a telephone interface, hearing device accessories, a smartphone or a smartphone app.

The term hearing device generally refers to an electronic device that assists the hearing of a person wearing the hearing device. In particular, the invention relates to a hearing device that is configured to fully or partially compensate for a hearing loss in a user with impaired hearing. Such a hearing device is also referred to as a “hearing aid” (HA). In addition, there are hearing devices that protect or improve the hearing of users with normal hearing, for example are meant to allow improved speech comprehension in complex hearing situations. Such devices are also referred to as “personal sound amplification products” (abbreviated to: PSAP). Finally, the term “hearing device” in the context used here also covers headphones (wired or wireless and with or without active noise cancelation) worn on or in the ear, headsets, etc. and also implantable hearing devices, for example cochlear implants.

Hearing devices in general, and hearing aids specifically, are usually configured to be worn on the head and, here, in particular in or on an ear of the user, in particular as behind the ear (BTE) devices or in the ear (ITE) devices. In terms of their internal structure, hearing devices normally have at least one output transducer, which converts an output audio signal supplied for the purpose of output into a signal that the user can perceive as sound, and outputs the signal to the user.

In most cases, the output transducer is in the form of an electroacoustic transducer that converts the (electrical) output audio signal into airborne sound, this output airborne sound being delivered to the auditory canal of the user. In the case of a hearing device worn behind the ear, the output transducer, which is also referred to as a “receiver”, is usually integrated in a housing of the hearing device outside the ear. The sound that is output by the output transducer is routed to the auditory canal of the user by means of a sound tube in this case. Alternatively, the output transducer may also be arranged in the auditory canal, and thus outside the housing worn behind the ear. Such hearing devices are also referred to as RIC devices, according to the term “receiver in channel”. Hearing devices worn in the ear, which have such small dimensions that they do not protrude outward beyond the auditory canal, are also referred to as CIC devices (according to the term “completely in canal”).

In other designs, the output transducer may also be in the form of an electromechanical transducer that converts the output audio signal into structure-borne sound (vibrations), this structure-borne sound being delivered to the cranial bone of the user, for example. Furthermore, there are implantable hearing devices, in particular cochlear implants, and hearing devices whose output transducers stimulate the user's auditory nerve directly.

In addition to the output transducer, a hearing device often has at least one (acousto-electric) input transducer. During operation of the hearing device, the or each input transducer receives airborne sound from the surroundings of the hearing device and converts this airborne sound into an input audio signal (i.e. an electrical signal that transports information about the ambient sound). This input audio signal—also referred to as “received sound signal”—is normally output in original or processed form to the user themselves, e.g. to produce a so-called transparency mode in headphones, for active noise cancelation or—e.g. in the case of a hearing aid—to achieve improved perception of sound by the user.

Furthermore, a hearing device often has a signal processing unit (signal processor). The or each input audio signal is processed (i.e. modified in terms of its sound information) in the signal processing unit. The signal processing unit outputs an accordingly processed audio signal (also referred to as “output audio signal” or “modified sound signal”) to the output transducer and/or to an external device.

Hearing device users face various challenges in using their hearing system. Typical challenges include (temporary) malfunction of the hearing device, often owing to dirt and sweat, difficulties in setting up and maintaining the smartphone connection to the hearing device, for example in order to stream music and make telephone calls, dissatisfaction with the properties of the amplified sound and the user-friendliness of the hearing device itself or a connected ear coupling or a charger.

The hearing device specialist is often the first point of contact for solving problems of this kind; they can be contacted only to a limited degree. In particular, it may be that the hearing device specialist is uncontactable when the problem occurs.

Although digital self-learning solutions as part of a smartphone app for hearing devices or on web pages are available at any time, the correct solution to the actual problem is difficult to find if it typically appears in FAQ lists or menu guidance.

The latest advances in generative text AI and linguistic data processing have afforded the opportunity for a human-like dialog between the hearing device wearer and an “always available” AI. However, commercially available chatbots lack specific information for solving hearing system problems, and so the quality of the advice for the hearing device user is limited. Furthermore, the user's problems are often very specific to the hearing system actually being worn and also depend on how the system (i.e. hearing device, ear coupling, app, telephone interface, accessories) has previously been adjusted or used, with the result that chatbots to date have been able to be used only to a limited extent for searching for solutions to hearing system problems.

### SUMMARY OF THE INVENTION

The invention is based on the object of specifying a particularly suitable method for operating a hearing system. In particular, solutions to hearing-system-specific problems ought to be provided in as simple, reliable and constantly available a manner as possible. The invention is also based on the object of specifying a particularly suitable hearing device for carrying out the method.

With the foregoing and other objects in view there is provided, in accordance with the invention, a method for operating a hearing system having a hearing device, a remote interaction unit with a user interface for inputting a hearing-system-related user query, a linguistic data processing section coupled to the user interface, and a data cloud, coupled to the linguistic data processing section, having a database storing responses for the hearing-system-related user query. The method includes the steps of: inputting the hearing-device-related user query; analyzing a content of the hearing-device-related user query by means of the linguistic data processing section and a further query being sent to the data cloud; taking, via the data cloud, the further query as a basis for selecting a response from the responses stored in the database; sending the response to the linguistic data processing section; taking, via the linguistic data processing section, the response as a basis for generating an output and sending the output to the remote interaction unit; and outputting the output by the remote interaction unit.

The invention achieves the object for the method by way of the features of the independent method claim and for the hearing system by way of the features of the independent hearing system claim. Advantageous arrangements and developments are the subject of the dependent claims (subclaims).

The advantages and arrangements listed for the method also apply, mutatis mutandis, to the hearing system, and vice versa. Where method steps are described below, advantageous arrangements arise for the hearing system in particular as a result of the hearing system being configured to perform one or more of these method steps.

The invention relates to a method for operating a hearing system. The hearing system in this case comprises at least one hearing device and a remote interaction unit having a user interface. The user interface is intended and configured for input of a hearing-system-related user query.

In the preferred application, the hearing device of the hearing system is a hearing device configured to take care of individuals with impaired hearing. In principle, however, the invention can also be applied to a hearing system having a “personal sound amplification device”. The hearing device exists in particular in one of the designs mentioned at the outset, in particular as a BTE, RIC, ITE or CIC device. The hearing instrument may furthermore also be an implantable or vibrotactile hearing aid.

The hearing device in this case is configured to receive sound signals from the surroundings and to output them to the user. The hearing device has a (hearing) device housing accommodating, by way of example, an input transducer, a signal processing device and an output transducer. The device housing is designed such that it can be worn by the user on the head and close to the ear, e.g. in the ear, on the ear or behind the ear.

The hearing device comprises at least one acoustic-electric input transducer, in particular a microphone, which is part of the receiving unit of the hearing system. The input transducer receives sound signals (noise, sounds, speech, etc.) from the surroundings during operation of the hearing device and converts the sound signals into an electrical input signal (acoustic data). By way of example, the in particular electro-acoustic output transducer is in the form of a (miniature) loudspeaker in order to generate an acoustic output signal on the basis of an audio signal generated by the signal processing device.

The remote interaction unit may be integrated, or implemented, in a peripheral device that is detached from the hearing device, e.g. in a smartphone or tablet computer. Preferably, the remote interaction unit is in the form of a (hearing device) app associated with the hearing device and interacting with the hearing device, the app being installed as intended on a smartphone or other mobile device. In this case, the smartphone, or mobile device, is normally itself not part of the hearing system, but rather is used by the hearing system only as an external resource.

The hearing system comprises a linguistic data processing section coupled to the user interface. By way of example, the user interface is a function of the remote interaction unit, or the app. The user interface is in the form of a digital assistant, for example. In particular, the user interface, or the digital assistant, is in the form of a chat or chat window in which the hearing system user can input in particular inputs in text form, for example by means of a screen keyboard in combination with a (smartphone) touchscreen.

A “chat” is intended to be understood here and below to mean in particular a text-based interaction between a hearing system user and the linguistic data processing section in which the communication takes place in natural language.

In this case, the user interface preferably comprises a chat window, that is to say a graphical element within the software application or app, that is used to display the user interaction in the chat. The chat window is in particular the interface that the hearing system user uses to interact with the linguistic data processing section.

The user query in this case is in particular a chat input, that is to say textual or verbal information that is input into the chat window, or into the user interface, by the hearing system user. This (chat) input may be written in natural language and is used to relay a query or message to the linguistic data processing section. The chat input can contain questions, instructions or general communication elements, which the linguistic data processing section interprets and processes in order to generate corresponding responses or actions. The user query in this case is for example a problem description from the hearing system user relating to a problem that they have with the hearing system. The user query may also be a question regarding a specific function of the hearing system.

A “linguistic data processing section” (natural language processing, NLP) is intended to be understood here and below to mean in particular an application of computer algorithms and techniques for analyzing and processing natural language in order to extract, understand or generate semantic, syntactic and pragmatic information from textual or verbal data sources. This encompasses the use of generative artificial intelligence (AI), large language models (LLMs) and other linguistic processing systems in order to perform tasks such as text classification, automated text generation, sentiment analysis, speech comprehension and similar tasks efficiently and precisely.

The linguistic data processing section is trained by means of common AI and NLP training methods. A typical example is training an LLM such as GPT-3, in which an immense volume of text data from the Internet is used as a training body. The model adapts its weightings and parameters in order to learn probabilities of the occurrence of words and combinations of words. This method allows the model to react to complex natural language inputs by generating context-related and meaningful responses or text generations.

In this case the linguistic data processing section is integrated into a network connected to the remote interaction unit, for example as software or an algorithm on a server or in a data cloud. In principle, however, it is also conceivable for the linguistic data processing section to be integrated on a local computer device, for example also in the remote interaction unit, and so no network or Internet connection to a remote server or a data cloud is required.

The hearing system furthermore comprises a data cloud, coupled to the linguistic data processing section, having a database that stores responses for the user query.

A data cloud (computing cloud), also called a cloud, is understood here and below to mean in particular a model that provides shared computer resources promptly when needed—usually over the Internet and independently of device—as a service, for instance in the form of servers, data memories or applications. The supply and utilization of these computer resources is defined, and is generally accomplished by way of a programming interface, or for users via a website or a program (for example app).

The linguistic data processing section is preferably coupled to the data cloud, or the database, by way of a programming interface (application programming interface, API). The linguistic data processing section uses the programming interface to send a query to the database, the database reacting by sending a response or solution back to the linguistic data processing section via the programming interface. The query in this case may also be (direct) database access by the linguistic data processing section, for example.

A “database” is understood here and below to mean in particular an organized and structured collection of electronic information that is stored and manageable in digital form. This information can include various types of data, such as text, numbers, graphics or multimedia, and is configured to be efficiently retrieved, searched and updated. In the method, the database is used as a central storage location for information that is accessed by the hearing system, or the linguistic data processing section, in order to provide responses or solutions for the user queries.

The database is configured as a comprehensive hearing system subject repository that stores a multiplicity of responses or solutions to hearing-device-specific user queries. In this case the database includes a generic repository comprising text and media that is configured such that it covers preferably the whole spectrum of solutions on the basis of a query, but also on the basis of different hearing device configurations.

By way of example, the database comprises at least twenty different subjects, in particular at least forty subjects, for example fifty subjects, which are grouped into subject areas, for example, in a repository. By way of example, the repository comprises six subject areas: hearing device (Hearing Aid), charger (Charger), accessories (Accessories), data connection (Connection), app use (App Use) and sound (Sound).

With regard to the subject area “hearing device”, responses are stored for example in respect of battery runtime, in respect of beeps or whistling in the hearing device, in respect of hearing device cleaning, in respect of inserting and removing the hearing device, in respect of switching the hearing device on and off, in respect of using a telecoil, in respect of a lost hearing device, in respect of an inoperative hearing device, recommended handling if a hearing device has become wet, or in respect of the operator control elements of the hearing device. Preferably, responses in this case are stored for different hearing device types or designs.

With regard to the subject area “charger”, responses are stored for example in respect of an LED display of the charger, in respect of a mains connector (power plug), in respect of a power bank, in respect of wireless (re) charging (e.g. via Qi), in respect of drying and cleaning, in respect of a non-charging charger, in respect of a faulty or lost charger, or in respect of insufficient charging by the charger. Preferably, responses in this case are stored for different charger types or designs.

With regard to the subject area “accessories”, responses are stored for example in respect of various supplementary devices that are coupled or couplable to the hearing device. By way of example, responses are stored in respect of using streaming devices, for example of a television (e.g. StreamlineTV), in respect of coupling (pairing) the hearing device to streaming devices, in respect of using a communication system, for example a telecoil (e.g. StreamLine Mic), in respect of coupling to a communication system, or in respect of an operator control element of the hearing device, for example a remote control (e.g. miniPocket).

With regard to the subject area “data connection”, responses are stored for example in respect of the wireless connectivity of the hearing device and/or the remote interaction unit, for example in respect of LoRa, Bluetooth, WiFi, UWB, WLAN, magnetic induction (e.g. T-coil, inter alia) or the mobile radio network. With regard to a Bluetooth connection of the hearing device, responses are stored for example in respect of coupling (pairing), in respect of connection difficulties/problems, in respect of hands-free streaming, in respect of operating-system-dependent streaming (e.g. Android streaming), or in respect of streaming configuration.

With regard to the subject area “app use”, responses are stored for example in respect of a remote interaction unit embodied as an app, or in respect of app-controlled adjustment of hearing device settings and parameters. By way of example, responses are stored in respect of adjusting a sound balance of the hearing device, volume adjustment, adjusting a directivity, in respect of general utilization of the app, in respect of changing a program, in respect of checking a battery status, in respect of stored health data relating to the user, in respect of (tinnitus) masking, in respect of the user interface, in respect of functions of the app, or in respect of coupling the app to external supplementary devices (e.g. a smartwatch).

The subject area “sound” relates to the hearing device settings or the fitting of the hearing device. There is provision in this regard for responses intended to bring about changes to the hearing device settings that are linked to a sonic problem/requirement and that can be applied (directly) to the hearing device (via a write connection) by the user interface, or the remote interaction unit, in order to solve sonic problems or meet sonic requests. The subject area contains stored details, for example for multiple different hearing device types and/or remote interaction units, regarding whether and, if so, which settings are able to be influenced or changed by a remote interaction unit in order to solve the query or the problem. The responses are therefore in particular settings changes based on the identification of the sound subtopic by way of the dialog with the hearing system user.

A “response” or “solution” is understood here and below to mean in particular the result or the output from the database in order to react to a query.

The method involves input of a hearing-device-related user query via the user interface resulting in a content of the user query first being analyzed by means of the linguistic data processing section and a query being sent to the data cloud. The input, or the user query, is thus used as a prompt for the linguistic data processing section, on the basis of which the linguistic data processing section generates the query for the data cloud, or database.

A “prompt” is intended to be understood here and below to mean in particular a text-based input or input invitation that is used to induce the linguistic data processing section to provide specific information, responses or generated content, in particular to provide the (database) query. A prompt may exist in the form of a sentence, a question, an invitation or a text fragment, and is used to obtain a response from the database. A prompt is processed for example by way of analysis of the content, followed by algorithmic query generation by the linguistic data processing section.

The data cloud then takes the query as a basis for selecting one of the stored responses from the database. If the query cannot be assigned a response from the database, the response selected is for example an error message to the effect of “User query not understood” or “Response cannot be found for user query”. The selected response is sent to the linguistic data processing section, the linguistic data processing section taking the response as a basis for generating an output and sending said output to the remote interaction unit, or to the user interface. Finally, the output is output by the remote interaction unit. This produces a particularly suitable method for operating the hearing system.

The data cloud, or the database, provides a standards-compliant linguistic data processing section, as text-generating AI, with a hearing-system-specific repository that preferably covers as wide as possible a range of problems and questions from the hearing system user. The linguistic data processing section uses this information as input in order to provide qualified responses or to optimize a dialog between a chatbot and the hearing system user, in order to solve the problem or to answer a question. The linguistic data processing section manages in particular the dialog with the hearing system user via the user interface, and contains a classification of the user query. Based on the user query, the linguistic data processing section requests the currently required database entry for the problem found, which is output to the hearing system user.

In an advantageous embodiment, a current hearing system configuration is determined in the course of the input of the user query and relayed to the data cloud. Preferably, the data cloud takes the hearing system configuration and the query as a basis for selecting a response from the database. This allows a hearing-system-specific response to be selected for the query, or the user query.

A “hearing system configuration” is intended to be understood here and below to mean in particular a configuration or setting of the hearing system or of at least one hearing system component (hearing device, remote interaction unit, optional supplementary devices, inter alia).

In this regard, the database contains for example a repository in respect of the hearing device capabilities, the remote input unit capabilities or smartphone/tablet capabilities, a configuration of the remote input unit (e.g. connection/pairing type), a utilization of supplementary devices (e.g. charger type, streamer), and fit setting of the hearing device (for example ear coupling, audio program).

The database thus preferably contains a generic response or solution repository, in particular containing the subject areas hearing device, charger, accessories, data connection and app use, and a hearing-system-specific response or solution repository, in particular containing the subject areas hearing device capabilities, remote input unit capabilities, or smartphone/tablet capabilities, configuration of the remote input unit, utilization of supplementary devices, and fit setting of the hearing device.

The generic repository consists of text and media, for example, and is configured such that it covers preferably the whole spectrum of solutions on the basis of the problem posed, but also on the basis of different hearing device configurations. The actual hearing system configuration (hearing device type and corresponding capabilities, adaptation configuration, accessories configuration, app configuration, telephone type) is forwarded from the remote interaction unit or to the data cloud, which can then provide the linguistic data processing section with a hearing-system-specific solution repository.

The hearing system configuration may be part of the user query or of an associated input invitation of the user interface, for example. Preferably, the hearing system configuration is determined or read by the remote interaction unit. In one conceivable arrangement, the hearing device has been or is coupled to the remote interaction unit (for example via Bluetooth) for signal transfer purposes, the remote interaction unit sending a status query to the hearing device, and the hearing device relaying a current hearing device configuration to the remote interaction unit.

The signal-transfer coupling between the hearing device and the remote interaction unit is preferably wireless. A wireless communication connection, for example a radio connection, is thus formed between the components. To this end, the hearing device and the electronic device comprise appropriate transceivers for data and signal interchange. The transceiver may be, for example, a radio frequency transceiver (e.g. LoRa, Bluetooth, WiFi, UWB, WLAN). Also conceivable is a transceiver for a signal transmission via magnetic induction (e.g. T-coil, inter alia) or by way of the mobile radio network.

In an advantageous embodiment, the remote interaction unit is used to detect a current remote interaction unit configuration (e.g. an app version, a smartphone operating system, settings of the remote interaction unit, inter alia). The relayed hearing device configuration and the detected remote interaction unit configuration are relayed to the data cloud as a hearing system configuration.

An additional or further aspect of the invention provides for the response transmitted to be text data and/or media data. In other words, the response stored in the database is text data and/or media data.

The conjunction “and/or” is intended to be understood here and below such that the features linked by means of this conjunction may be produced either together or as alternatives to one another.

“Text data” are intended to be understood to mean for example information about a subject or subject area in text form that is stored in the database. The text data can be output by the database as a response or part of the response. The text data can be forwarded to the user interface by the linguistic data processing section essentially without alteration in this case. Alternatively, the linguistic data processing section can also analyze or process the text data, and can take this as a basis for generating a text output for the remote interaction unit, or for the user interface, for example.

“Media data” are intended to be understood here and below to mean in particular digital information or content that can exist in various media formats, such as images, videos, audio recordings, PDF documents or other multimedia files. These media data are used to represent visual, audible or audiovisual information and are stored in the database in order to be available as a response or part of the response to user queries. This allows the information or explanations to be output for the response in visual, audible or other multimedia form. The media data selected as the response or part of the response are preferably as accurate, relevant and comprehensible a reaction to the user query as possible.

The repository thus preferably consists of text and media. If the linguistic data processing section has multimedia capability, it can use all types of solution repositories, i.e. text and media. If the linguistic data processing section is not capable of processing and/or using media, the classification of the linguistic data processing section can be used for example to provide the hearing system user with other media suited to the problem mentioned by the hearing system user. By way of example, the output in this case is forwarded to a different image material in the remote interaction unit, or user interface, on the basis of the problem found.

In one possible form, the linguistic data processing section is trained using feedback that is input via the user interface in response to the output. By way of example, part of the output that is presented is a question in text form regarding whether the output was able to solve a problem described in the user query or was helpful. The feedback in response thereto is used to train the linguistic data processing section. This allows the linguistic data processing section to be trained on the basis of conversations and dialogs with the hearing system user in order to prioritize the parts of the database that, from the point of view of the hearing system user, contribute most to solving or answering their user query.

The hearing system according to the invention is intended and also suitable and configured for carrying out a method described above. The hearing system comprises a hearing device, a remote interaction unit having a user interface, a linguistic data processing section and a data cloud having a database. The linguistic data processing section in this case is an interface between the remote interaction unit (or user interface) and the data cloud (or database) that converts user queries into (database) queries and converts the (database) responses into corresponding (user interface) outputs. This produces a particularly suitable hearing system.

In particular, a hearing system is thus provided in which user queries can be automatically answered for a hearing system user virtually around the clock. The database access thus allows the linguistic data processing section to generate hearing-system-specific responses for a chatbot, as a result of which a reliable and fast search for a solution to hearing system problems is possible. In other words, conversational AI is provided by the personalized hearing device texts and media stored in the database, which permits problems of the hearing system user to be solved in a human-like dialog.

Other features which are considered as characteristic for the invention are set forth in the appended claims.

Although the invention is illustrated and described herein as embodied in a method for operating a hearing system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration showing a hearing system having a hearing device and having a remote interaction unit and also having a linguistic data processing section and a data cloud;

FIG. 2 is a block diagram showing a method for operating the hearing system in accordance with a first embodiment; and

FIG. 3 is a block diagram showing the method for operating the hearing system in accordance with a second embodiment.

Mutually corresponding parts and quantities are provided with the same reference signs throughout the figures.

### DETAILED DESCRIPTION OF THE INVENTION

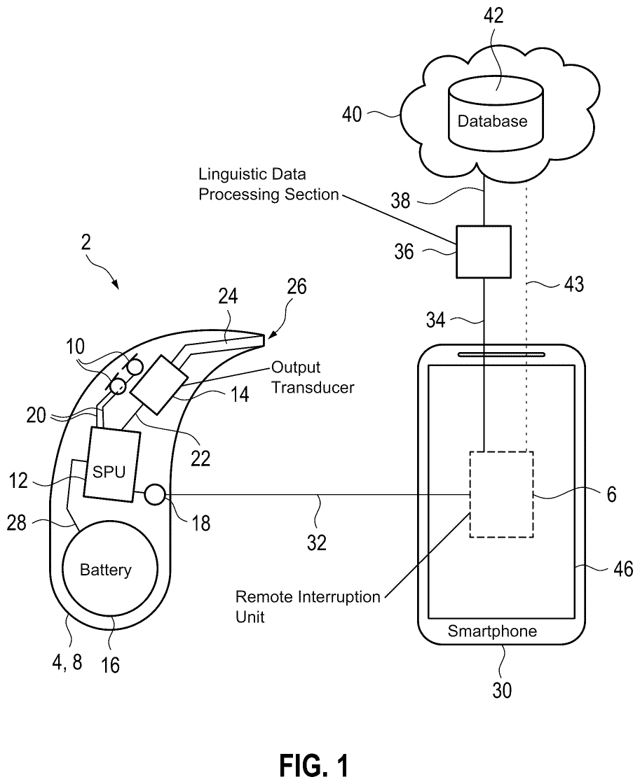

Referring now to the figures of the drawings in detail and first, particularly to FIG. 1 thereof, there is shown a schematic and simplified representation of a hearing system 2 that encompasses a hearing device 4 and a remote interaction unit 6. The hearing device 4 in the exemplary embodiment shown is a BTE hearing device by way of illustration.

The hearing device 4 encompasses a (hearing device) housing 8 that is to be worn behind the ear of a user with impaired hearing and that contains, as main components, two input transducers 10 in the form of microphones, a signal processing unit 12 having a digital signal processor (e.g. in the form of an ASIC) and/or having a microcontroller, an output transducer 14 in the form of a receiver and a battery 16. The hearing device 4 furthermore encompasses a transceiver 18 for in particular wirelessly interchanging data, for example on the basis of the Bluetooth standard.

During operation of the hearing device 4, the input transducers 10 are used to receive ambient sound from the surroundings of the hearing device 4 and to output the ambient sound to the signal processing unit 12 as an audio signal 20 (i.e. as an electrical signal carrying the sound information). The signal processing unit 12 processes (filters, amplifies, attenuates, inter alia) the audio signal 20. To this end, the signal processing unit 12 encompasses a multiplicity of signal processing functions, among others an amplifier that amplifies the audio signal 20 on a frequency-dependent basis in order to compensate for the hearing impairment of the user.

The signal processing unit 12 outputs a modified audio signal 22 resulting from this signal processing to the output transducer 14. The output transducer in turn converts the modified audio signal 22 into sound. This sound (which is modified compared with the received ambient sound) is routed by the output transducer 14 first through a sound channel 24 to a tip 26 of the housing 8, and from there through a sound tube (not shown explicitly) to an earmold that is insertable or inserted into the ear of the user.

The signal processing unit 12 is supplied with electrical energy 28 from the battery 16.

The remote interaction unit 6 in the exemplary embodiment shown is realized as software in the form of an app that is installed on a smartphone 30. The smartphone 30 in this case is preferably a smartphone of the hearing device user. The smartphone 30 is itself not part of the hearing system 2 and is merely utilized by the hearing system as a resource. Specifically, the remote interaction unit 6 utilizes memory space and computing power of the smartphone 30 to carry out a method for operating the hearing system 2, or the hearing device 4, that is described in more detail hereinbelow. Furthermore, the remote interaction unit 6 utilizes a Bluetooth transceiver (not shown in more detail) of the smartphone 30 for wireless communication, i.e. for data interchange with the hearing device 4 via a wireless signal or communication connection 32 (Bluetooth connection) to the transceiver 18, indicated in FIG. 1. The communication connection 32 is set up by pairing the smartphone 30, or the remote interaction unit 6, with the hearing device 4.

A further wireless or wired (data) communication connection 34, for example based on the IEEE 802.11 standard (WLAN) or a mobile radio standard, e.g. LTE, furthermore connects the remote interaction unit 6 to a linguistic data processing section 36. By way of example, the linguistic data processing section 36 comprises a cloud infrastructure. The functions of the linguistic data processing section 36 are, to this end, hosted on one or more servers, for example, and accessible via the Internet.

The linguistic data processing section 36 is connected to a data cloud (cloud) 40, which is arranged in the Internet and in which a database 42 is installed, by way of a wireless or wired (data) communication connection 38. The database 42 may also be a server coupled to the data cloud 40. The linguistic data processing section 36 contains a programming interface (API), which is not denoted in more detail.

The communication connection 32 is used by the linguistic data processing section 36 to manage the dialog, or the chatbot, the communication connection 38 being used to put queries in respect of hearing-system-specific subjects to the database 42.

The remote interaction unit 6 is optionally coupled or couplable directly to the data cloud 40 by way of a communication connection 43.

For data interchange with the linguistic data processing section 36 and/or with the database 42, the remote interaction unit 6 accesses a WLAN or mobile radio interface (likewise not shown explicitly) of the smartphone 30.

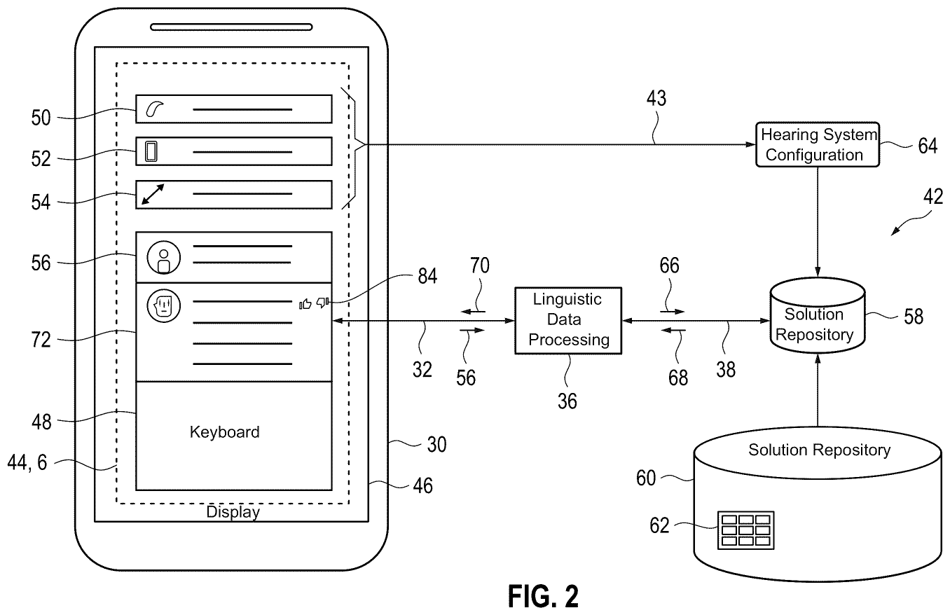

A method for operating the hearing system 2 is explained in more detail hereinbelow with reference to FIG. 2.

The remote interaction unit 6 contains a user interface 44 for interacting with a hearing system user. By way of example, the user interface 44 is embodied as an assistance function (digital assistant), in particular in the form of a chat or chat window. The smartphone 30 has a touch-sensitive display 46 as touchscreen, and so the hearing system user can enter inputs in text form by means of a screen keyboard 48 of the user interface 44 as input means.

In this embodiment, the user interface 44 has three input rows 50, 52, 54, for example. The input rows 50, 52, 54 can be used by the hearing system user to make hearing-system-specific inputs. By way of example, the input row 50 can be used to input a type or a device number of the hearing device 4, the input row 52 can be used to input a smartphone type, and the input row 54 can be used to input a pairing type, that is to say the type of the communication connection 32.

If the hearing system user 32 inputs a user query 56 into the user interface 44, or into the chat window, by means of the screen keyboard 48, a chatbot responds by means of the linguistic data processing section 36, wherein the linguistic data processing section 36 accesses the database 42.

The text input or chat input of the user query 56 is relayed to an (API) endpoint of the linguistic data processing section 36 via the communication connection 32. The linguistic data processing section 36 processes the user query 56, or a corresponding prompt, by means of an LLM and uses the programming interface to access the database 42 of the data cloud 40. The method involves the linguistic data processing section 36 being provided with a hearing-system-specific response or solution repository 58 in this case.

The data cloud 40, or the database 42, contains a general, non-hearing-system-specific, solution repository 60. By way of example, the solution repository 60 comprises fifty subjects, divided for example into five subject areas (hearing device, charger, accessories, data connection/pairing and app use). The subjects are stored in one or more tables as text or text data 62, for example.

To provide the hearing-system-specific solution repository 58, the information of the input rows 50, 52, 54 is relayed to the data cloud 40 as hearing system configuration 64. The data cloud 40 takes the relayed hearing system configurations 64 as a basis for determining those entries of the solution repository 60 that relate to the hearing system 2, and thus produces the hearing-system-specific solution repository 58. In other words, the solution repository 58 is selected from the solution repository 60 on the basis of the information of the hearing system configuration 64.

In the course of processing the user query 56, the linguistic data processing section 36 generates a (database) query 66 that is sent to the data cloud 40 via the communication connection 38. The data cloud 40 produces the solution repository 58, from which a solution or response 68 is selected on the basis of the query 66 and sent to the linguistic data processing section 36.

The linguistic data processing section 36 processes the user query 56 using the relayed response 68, and generates an output 70. The output 70 is sent to the remote interaction unit 6, and there it is forwarded to the hearing system user by the chatbot as chat output (chat response) 72 in the chat window of the user interface 44.

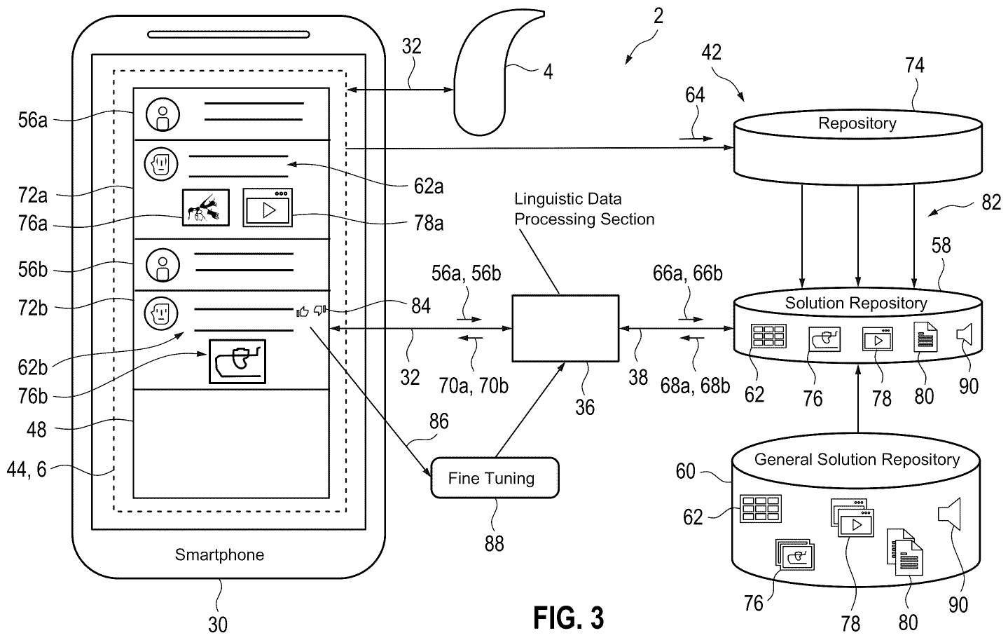

A development of the method described hereinabove is explained in more detail hereinbelow with reference to FIG. 3.

In this exemplary embodiment, the user interface 44 has no input rows 50, 52, 54. In the course of an input into the user interface 44, the remote interaction unit 6 determines or detects the hearing system configuration 64 and relays the hearing system configuration to the data cloud 40 via the communication connection 43. To this end, the remote interaction unit 6 uses the signal-transfer communication connection 32 to the hearing device 4 to determine or detect the hearing device configuration thereof. By way of example, part of the hearing device configuration relayed is the type of hearing device or the hearing device type and the fitting configuration or fitting settings of the hearing device 4. Furthermore, the remote interaction unit 6 is used to detect or determine the smartphone configuration, an app configuration and a pairing configuration, for example. These individual or component configurations are combined to produce the hearing system configuration 64.

By way of example, the data cloud 40, or the database 42, comprises a repository 74 in respect of the hearing device capabilities, the remote input unit capabilities or smartphone/tablet capabilities, a configuration of the remote input unit (e.g. connection/pairing type), a utilization of supplementary devices (e.g. charger type, streamer), and fit setting of the hearing device (for example ear coupling, audio program). The hearing system configuration 64 is taken as a basis for determining the information relevant to the hearing system 2 from the repository 74.

The general solution repository 60 in this embodiment also comprises, in addition to text data 62, media data in the form of image data 76, video data 78 and document data (for example guidance, instructions for use, brochures, inter alia) 80. The document data 80 are PDF data, for example.

In a specific exemplary embodiment, the hearing system 2 comprises for example a binaural hearing device 4 having two individual devices. The individual devices in this case are embodied as ITE devices, for example. If one of the individual devices is not working, the hearing system user can input a user query 56a into the user interface 44. By way of example, the hearing system user enters something along the lines of “my left hearing device has not been working since this morning”.

With the input, the remote interaction unit 6 detects or determines the hearing system configuration 2 and relays the hearing system configuration via the communication connection 43. The user query 56a is sent to the linguistic data processing section 36, which dispatches a corresponding query 66a to the data cloud 40.

On the basis of the hearing system configuration 64 and the repository 74, the data cloud determines information 82 about the hearing system 2. By way of example, the hearing device configuration is taken as a basis for determining that the hearing device 4, or the individual devices thereof, are rechargeable ITE devices with Bluetooth that support directional microphone use and hands-free use, and are compatible with an ITE charger. Furthermore, the smartphone configuration is taken as a basis for determining that the smartphone operating system supports an ASHA radio protocol (ASHA: Audio Streaming for Hearing Aids). Furthermore, the fitting configuration can be taken as a basis for determining that the hearing device 4 is equipped with domes, own voice processing (OVP) and an additional program for loud surroundings.

This information is taken as a basis for filtering the solution repository 60 and selecting those text data 62 and media data 76, 78, 80 for the solution repository 58 that are appropriate to the hearing system 2. A response 68a consisting, for example, of text data 62a, an image file 76a and a video file 78a is selected from the solution repository 58. By way of example, the chat output 72a resulting from the output 70a is a text, which is something along the lines of “Please check your ITE for a buildup of wax. View the video and image below.”, and a thus presented image from the image file 76a and a video from the video file 78a.

In the exemplary embodiment shown, the chat output 72a does not solve the problem of the hearing system user, and they input a second user query 56b, which is something along the lines of “I have done so, everything is okay, but it is still not working”, for example. Consequently, a second query 68b is generated, and a new response 68b is selected from the solution repository 58. By way of example, the response 68b contains text data 62b and a further image file 76b, which are sent as output 70b to the chatbot, which consequently outputs a chat output 72b containing a text along the lines of “Please put your ITE into the charger for 20 s and check the LED . . . ” and a corresponding image of an ITE in a charger.

Preferably, part of the chat output 72b generated and displayed is two feedback buttons 84, which can be operated by the hearing system user using the (touch) display. By way of example, one of the feedback buttons 84 is linked to positive feedback (“thumbs up”, “response has helped”, inter alia) and the other is linked to negative feedback (“thumbs down”, “response has not helped”, inter alia). Operating one of the feedback buttons 84 results in corresponding feedback 86 being produced that is taken as a basis for training the linguistic data processing section 36 by way of fine tuning or personalization 88 in such a way that it can better assist the hearing system user in future. The fine tuning 88 is thus a training for the linguistic data processing section 36.

In an additional or alternative embodiment, the solution repository 60 furthermore comprises settings data 90. The settings data 90 contain information about whether and which hearing device settings can be set for different hearing systems 2. The settings data 90 furthermore contain information about which of these hearing device settings are relevant for the respective user query 56, 56a, 56b, and also the specific settings and changes for producing a suitable hearing device setting or hearing device configuration. The settings data 90 possibly also contain information about how these hearing device settings can be set, for example if they cannot be set automatically by the remote interaction unit 6.

The solution repository 58 preferably contains only settings data 90 that can be transmitted to the hearing device 4 via the communication connection 32 in order to set said hearing device. This allows the chatbot to directly or indirectly (that is to say by means of actions by the user) also make changes to the hearing device settings in the course of the dialog with the hearing system user.

In this case, it is conceivable, by way of example, for the chatbot to access a settings or assistance function of the remote interaction unit 6 by means of which the settings on the coupled hearing device 4 are changed. It is likewise conceivable for the chatbot to access or refer to a further software, in particular a further smartphone app installed on the smartphone 30 in addition to the remote interaction unit 6, in order to relay the settings data 90 to the hearing device 4, or to (directly or indirectly) change the hearing device settings. By way of example, the chatbot can explain how the hearing device settings can be set using the remote interaction unit 6 or using a smartphone app executed separately from the remote interaction unit 6. For the latter, the hearing system configuration 64 comprises for example information about what other apps are installed on the smartphone 30.

By way of example, a user query along the lines of “background noise is too loud” results in the chat output initially output by the chatbot being text data of the settings data 90, and the user being asked whether a hearing device specialist (hearing care provider) has stored for example different hearing programs for the hearing device 4 that are selectable via the remote interaction unit 6 (or a separate app). If the user answers this in the negative by way of a further user query, and the hearing device 4 comprises a directional microphone function (directional focus), then, by way of example, a chat output is generated, on the basis of the settings data 90, for how the directional effect or directional characteristic can be temporarily changed or set. If the user then uses a user query to request that the settings be permanently adopted on their hearing device 4, the settings data 90 can be used to output, for example, an instruction containing a text/image reference to an assistance function of the remote interaction unit 6 as a chat output, by means of which the settings can be permanently adapted.

The claimed invention is not limited to the exemplary embodiments described hereinabove. Rather, other variants of the invention can also be derived therefrom by a person skilled in the art within the scope of the disclosed claims without departing from the subject matter of the claimed invention. In particular, all the individual features described in association with the various exemplary embodiments can furthermore also be combined in another way within the scope of the disclosed claims without departing from the subject matter of the claimed invention.

The following is a summary list of reference numerals and the corresponding structure used in the above description of the invention:
2 hearing system
4 hearing device
6 remote interaction unit
8 housing
10 input transducer
12 signal processing unit
14 output transducer
16 battery
18 transceiver
20, 22 audio signal
24 sound channel
26 tip
28 energy
30 smartphone
32, 34 communication connection
36 linguistic data processing section
38 communication connection
40 data cloud
42 database
43 communication connection
44 user interface
46 display
48 screen keyboard
50, 52,54 input row
56, 56a, 56b user query
58 solution repository
60 solution repository
62, 62a, 62b text data
64 hearing system configuration
66, 66a, 66b query
68, 68a, 68b response
70, 70a, 70b output
72, 72a, 72b chat output
74 repository
76, 76a, 76b image data
78, 78a video data
80 document data
82 information
84 feedback buttons
86 feedback
88 fine tuning
90 settings data

1. A method for operating a hearing system having a hearing device, a remote interaction unit with a user interface for inputting a hearing-system-related user query, a linguistic data processing section coupled to the user interface, and a data cloud, coupled to the linguistic data processing section, having a database storing responses for the hearing-system-related user query, which comprises the steps of:
inputting the hearing-device-related user query;
analyzing a content of the hearing-device-related user query by means of the linguistic data processing section and a further query being sent to the data cloud;
taking, via the data cloud, the further query as a basis for selecting a response from the responses stored in the database;
sending the response to the linguistic data processing section;
taking, via the linguistic data processing section, the response as a basis for generating an output and sending the output to the remote interaction unit; and
outputting the output by the remote interaction unit.

2. The method according to claim 1, which further comprises determining a current hearing system configuration in a course of an input of the hearing-device-related user query and the device-related user query being relayed to the data cloud.

3. The method according to claim 2, wherein the data cloud takes the current hearing system configuration and the further query as a basis for selecting the response from the database.

4. The method according to claim 2, wherein the hearing device is coupled to the remote interaction unit for signal transfer purposes, the hearing device relays the current hearing device configuration to the remote interaction unit.

5. The method according to claim 4, which further comprises using the remote interaction unit to detect a current remote interaction unit configuration, and the current hearing device configuration and the current remote interaction unit configuration are relayed to the data cloud as a hearing system configuration.

6. The method according to claim 1, wherein the response that is transmitted has text data and media data.

7. The method according to claim 1, wherein the linguistic data processing section is trained using feedback that is input via the user interface in response to the output.

8. A hearing system, comprising:
a hearing device;
a remote interaction unit having a user interface for inputting a hearing-system-related user query;
a linguistic data processing section coupled to said user interface;
a data cloud, coupled to said linguistic data processing section, having a database storing responses for the hearing-device-related user query; and
the hearing system configured to carrying out the method according to claim 1.
